(19) United States
(12) Patent Application Publication
(10) Pub. No.: US 2015/0142596 A1
(43) Pub. Date: May 21, 2015

(54) Commercial transactions via a wearable computer with a display

(71) Applicants: Gabriel Jakobson, Alamo, CA (US); Steven Rueben, Las Vegas, CA (US)

(72) Inventors: Gabriel Jakobson, Alamo, CA (US); Steven Rueben, Las Vegas, CA (US)

(21) Appl. No.: 13/998,623

(22) Filed: Nov. 18, 2013

(51) Int. Cl. G06Q 20/20; G02B 27/01; G06K 9/00

(52) U.S. Cl. CPC G06Q 20/209; G06K 9/00288; G02B 27/017
USPC 705/24

(57) ABSTRACT

A method and system for conducting commercial transactions via a wearable computer coupled to a display, comprising the steps of: means for capturing at least one face image of a first person acting as buyer in a commercial transaction, wherein the at least one face image is captured via the wearable computer used by a second person acting as merchant; means for capturing additional transactional information including: identification of goods-or-services being transacted and monetary amount owed; means for transmitting the at least one face image and the additional transactional information to a remote processing entity; means for discerning identity of the first person and associating an account with the first person; means for attempting to debit the user account with the monetary amount owed and means for transmitting results of attempt to debit the user account to the wearable computer and displaying the results to the second person.

### FIELD OF INVENTION

The present invention generally relates to wearable computers with displays. More particularly, the present invention relates to a system enabling a wearable computing device equipped with a display/optical head-mounted display (“OHMD”) to conduct commercial transactions.

### BACKGROUND OF THE INVENTION

Wearable computers, also known as body-borne computers are miniature electronic devices that are worn by the bearer under, with or on top of clothing, as watches or as eye glasses. This class of wearable technology has been developed for general or special purpose information technologies and media development. Wearable computers are especially useful for applications that require more complex computational support than just hardware coded logics.

One of the main features of a wearable computer is consistency. There is a constant interaction between the computer and user, i.e. there is no need to turn the device on or off. Another feature is the ability to multi-task. It is not necessary to stop what you are doing to use the device; it is augmented into all other actions. These devices can be incorporated by the user to act like a prosthetic. It can therefore be an extension of the user's mind and/or body.

Optical head-mounted display (“OHMD”) is a wearable display that has the capability of reflecting projected images as well as allowing the user to optically see-through it, and is often coupled with a wearable computer. Google Glass® is one example of a wearable computer coupled with an OHMD. Wearable computers with OHMD may display information in a smartphone-like hands-free format that can communicate with the Internet via natural language voice commands. Other types of displays are used by wearable computers, such as LCD displays for smart-watches, etc.

Mobile payment, also referred to as mobile money, mobile money transfer, and mobile wallet generally refer to payment services operated under financial regulation and performed from or via a mobile device. Instead of paying with cash or credit cards, a consumer can use a mobile phone to pay for a wide range of services and digital or hard goods. Some example of mobile payment providers/technologies are companies like Square, Inc. Square Register® allows individuals and to accept debit and credit cards on their iOS® or Android® smartphone or tablet computer. The app supports manually entering the card details or swiping the card through the Square Reader, a small plastic device which plugs into the audio jack of a supported smartphone or tablet and reads the magnetic stripe. On the iPad® version of the Square Register app, the interface resembles a traditional cash register. Square Wallet® allows customers to set up a tab and pay for their order simply with their name (or a barcode) using a stored credit, debit, or gift card.

### SUMMARY OF THE INVENTION

In general, a method and system for facilitating financial transactions via devices that are wearable computers equipped with a display or optionally, an optical head-mounted display (“OHMD”), wherein a user wearing the device (e.g. a merchant) is able to use the device to capture video and audio related to the transaction, transmit the captured audio/video to a transaction processing center, and be provided with acknowledgement of the transactions success, failure. For example, in one possible embodiment, the merchant may utilize the device to capture and transmit an image of the face of a customer and audio depicting the transaction (e.g. “I agree to pay $100 for this item”). The transmitted image may be processed by a service (e.g. on the internet/“in the cloud”) where the image of the person's face may be identified and matched with an existing account; the audio may be transcribed so that the account is debited the correct amount, and the merchant may receive an electronic acknowledgement on the device of the transaction approval/completion.

### DESCRIPTION OF THE DRAWINGS

For a more complete understanding of the present invention and further advantages thereof, references are now made to the following Detailed Description, taken in conjunction with the drawings, in which:

FIG. 1 is a generalized diagram illustrating a wearable computer with a display/an optical head-mounted display (“OHMD”), known in the prior art, as may be applicable in one embodiment of the present invention.

FIGS. 2a-2c are generalized block diagrams illustrating utilizing a wearable computer with a display/an optical head-mounted display (“OHMD”) to conduct merchant-customer transactions, via facial recognition and sound recording, in one embodiment of the present invention.

FIGS. 3a-3c are generalized block diagrams illustrating utilizing a wearable computer with a display/an optical head-mounted display (“OHMD”) to conduct merchant-customer transactions, via credit card recognition, in one embodiment of the present invention.

FIG. 4 is a generalized flow diagram illustrating a system in which a wearable computer with a display/an optical head-mounted display (“OHMD”) may be used to facilitate merchant transactions, in one embodiment of the present invention.

FIG. 5 is a generalized block diagram illustrating workings/components of a system in which a wearable computer with a display/an optical head-mounted display (“OHMD”) may be used to facilitate merchant transactions, in one embodiment of the present invention.

FIG. 6 is a generalized block diagram illustrating one system in which a wearable computer with a display may be used to facilitate merchant transactions, in one embodiment of the present invention.

### DETAILED DESCRIPTION

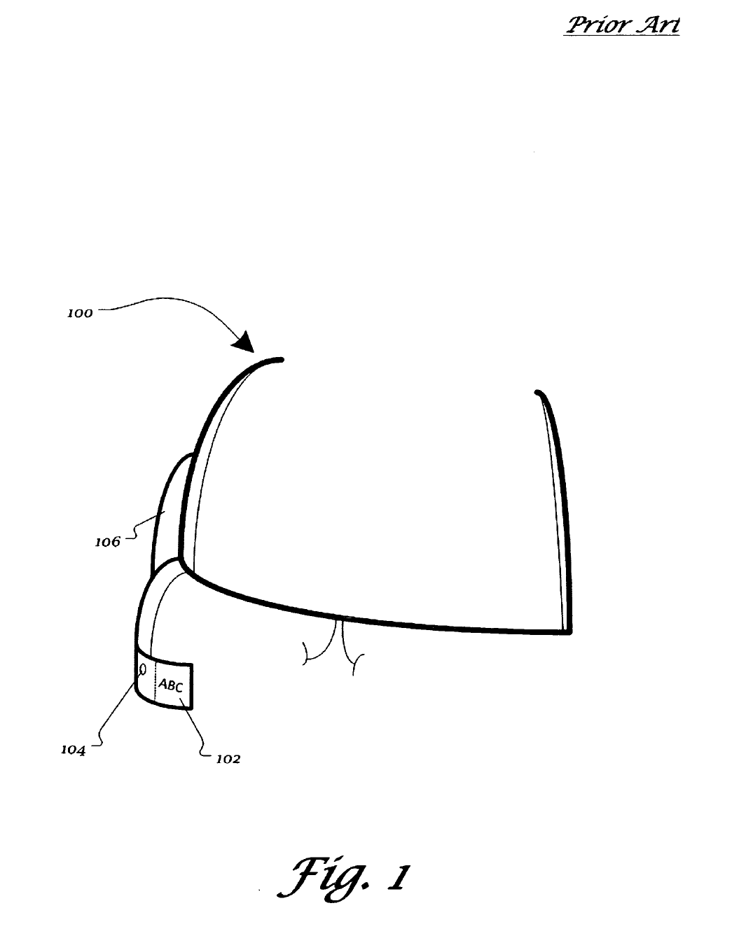

FIG. 1 is a generalized diagram illustrating a wearable computer with an optical head-mounted display (“OHMD”), known in the prior art, as may be applicable in one embodiment of the present invention. In the prior art, a wearable device 100, e.g. having a shape of human-wearable glasses, may include an OHMD 102 (or optionally, any other type of display in case of wearable computer not worn over a user's head), a camera 104, and a housing 106 for a host of other recording/power/communication technologies (e.g. a processor, a WiFi transmitter/receiver, a Bluetooth communication unit, a storage/memory unit, a gyroscope, an accelerometer, a magnometer, a microphone/bone-conduction transducer, a battery, etc.)

In the prior art, the wearable device 100 may communicate with the internet directly, or via a proxy electronic device, such as a smartphone. The wearable device 100 may be capable of recording, processing and transmitting audio/video from the wearer/user to the internet; and, display to the user information received from the internet. For example, the user may issue a spoken command (or touch command or movement), such as “record video”, in response to which audio/video media may be generated (e.g. recording a movie or still shots of the user's field of view) and transmitted to a source on the internet. Information on the internet may be transmitted back to the wearable device 100 and displayed to the user via the OHMD 102.

In other implementation known in the prior art, various components of the wearable device 100 may be integrated into other devices/wearable forms (e.g. retrofitted onto sun glasses, clothing, watches, and any other wearable/carry-able items).

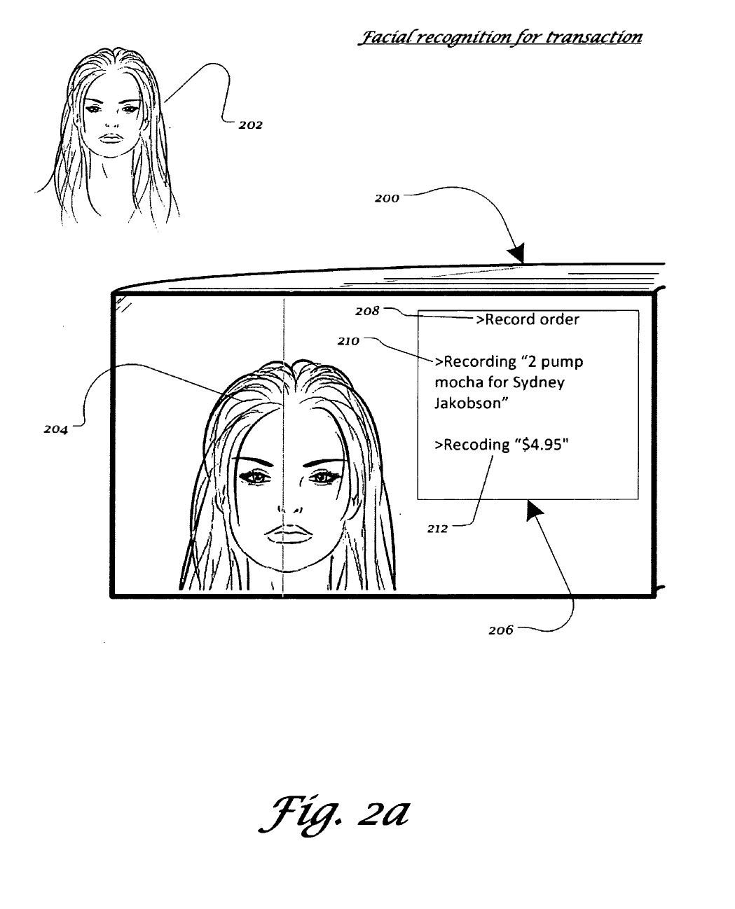

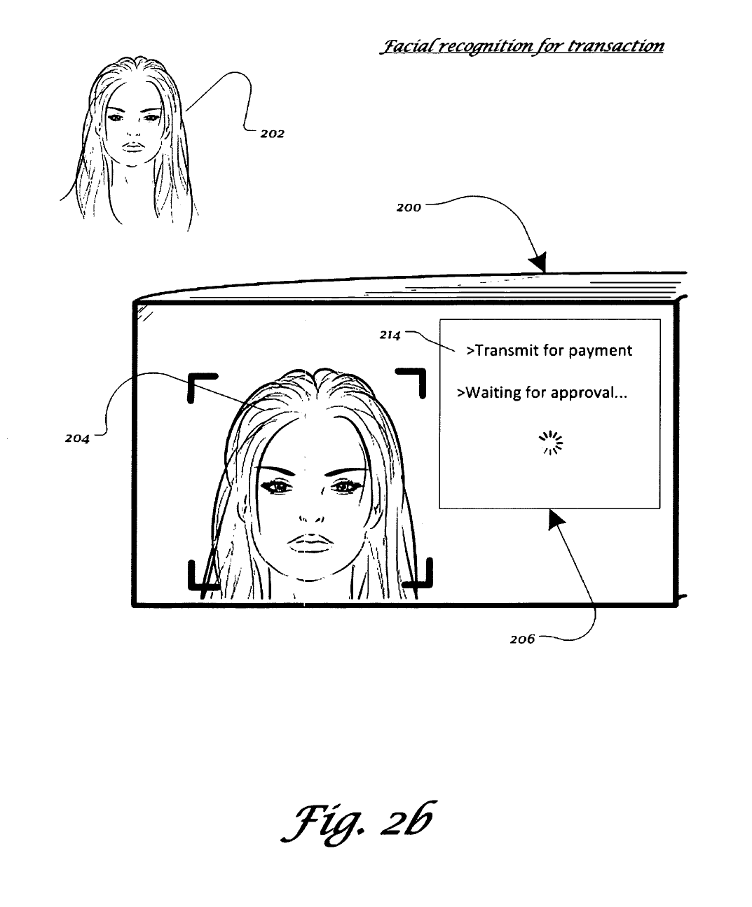

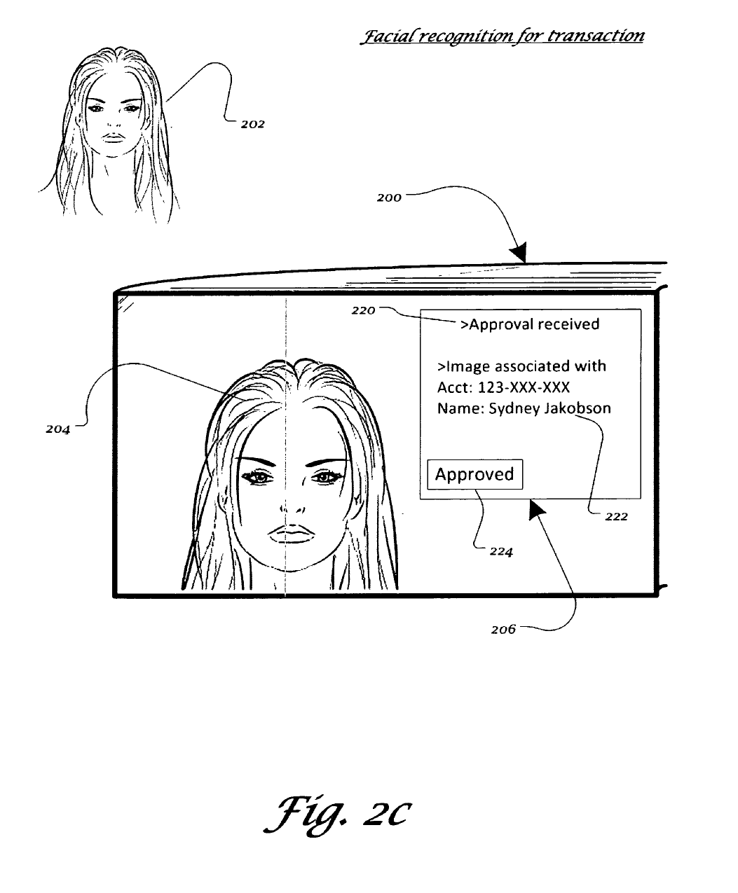

FIGS. 2a-2c are generalized block diagrams illustrating utilizing a wearable computer with a display (in this illustration, an optical head-mounted display “OHMD”) to conduct merchant-customer transactions, via facial recognition and sound recording, in one embodiment of the present invention. A merchant may utilize such device to conduct a business transaction in lieu of other forms of transacting/payment, such as a charging a credit card via a credit card reader. In the embodiments described in FIGS. 2a-2c, a merchant may conduct a business transaction with use of the wearable computer's ability to record and transmit audio/video and receive and display a transaction status/confirmation.

Referring now to FIG. 2a, a person (e.g. “customer”) 202 may face a user (e.g. “merchant”) wearing a wearable computer, the wearable computer including a display 200 (in this illustration, an n OHMD), through which the customer 202 may be visible (the customer 202 may be displayed in the OHMD 200 as an image of the customer 204). A notification area 206 may be included in field of view of the OHMD 200. The notification area 206 may include feedbacks of commands issued to the wearable computer, information sent and received, etc.

Commands issued via voice (or touch, movement, or any other means) may be displayed (e.g. “Record order” 208 in the notification area 206) optionally as an entire transcript of a transaction. For example, in response to the merchant's saying “Record order” (displayed as 208), a system/software confirmation such as Recording “2 pump mocha for Sydney Jakobson” 210 etc., may be displayed.

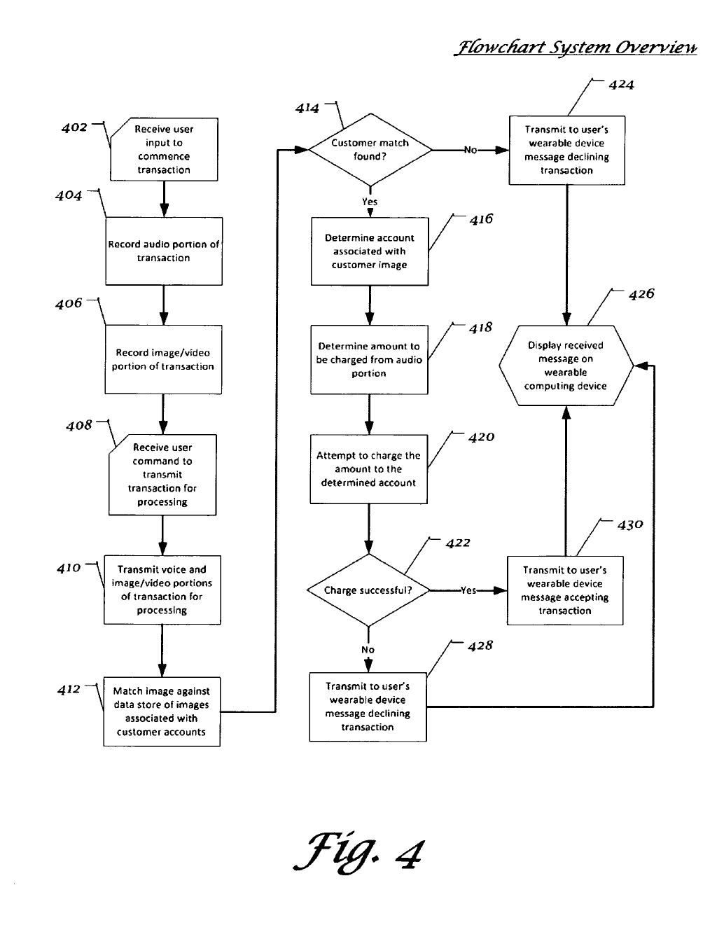

Referring now to FIG. 2B, a communication capturing the transaction request depicted in FIG. 2a, may be transmitted for processing “in the cloud” (i.e. interne, e.g. via a cellular device, such as a smart phone, paired with the wearable computer). More detailed information on cloud-transaction processing is provided in FIGS. 4-6. The merchant may receive transmittal/waiting-for-approval indication 214 within the OHMD 206. A metaphorical equivalent would be a credit card transaction where the merchant had entered data depicting the transaction (i.e. total dollar amount), had swiped the customer's credit card (or otherwise entered/captured the credit card number, expiration date, etc.) and has submitted all the data electronically to the bank for processing, awaiting an approval or decline of the transaction.

Referring now to FIG. 2C, the display/OHMD 206 may display approval/decline response received from the cloud regarding the transaction. E.g. “Approval received” 220 and “Approved” 224 as a visual cue/status update to the merchant. Additional information, such as “Image associated with Acct: 123-XXX-XXX Name: Sydney Jakobson” 222 may also be displayed to the merchant, providing more transactional detail. In this example, a facial recognition mechanism implemented in the cloud may have recognized the image 204 of the customer and have found an account associated with the recognized customer to debit. Upon successful debiting (in this example), the merchant is displayed a confirmation (equivalent of “approved” appearing on a credit card reading machine in the prior art.)

In related possible embodiments, other information may be displayed in the OHMD, ranging from advertising information targeted at the specific customer, having been facially recognized, to information declining the transaction and any related explanations.

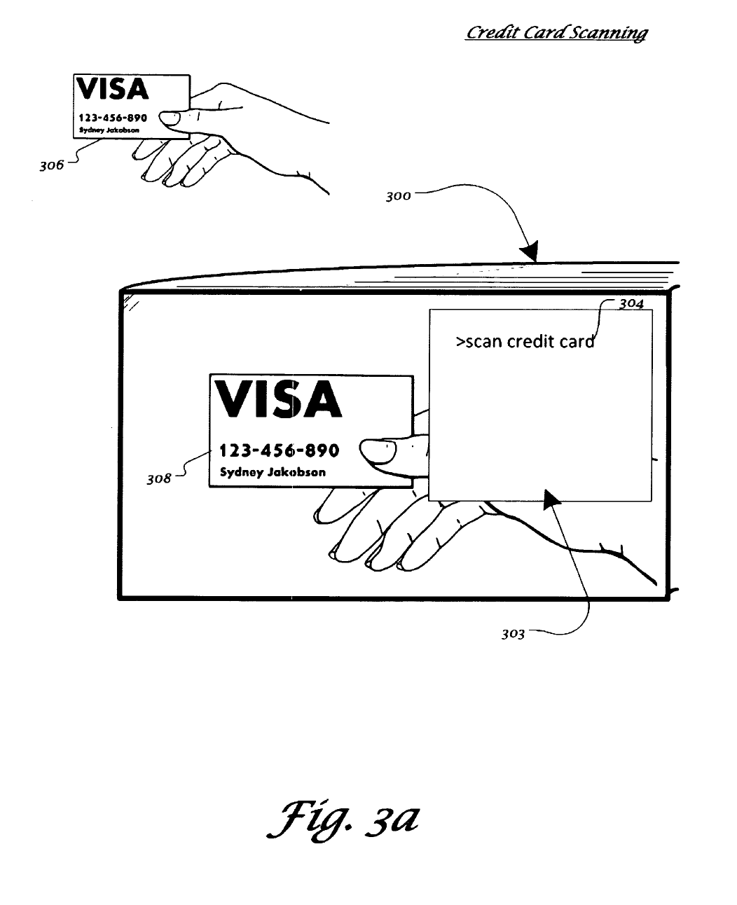

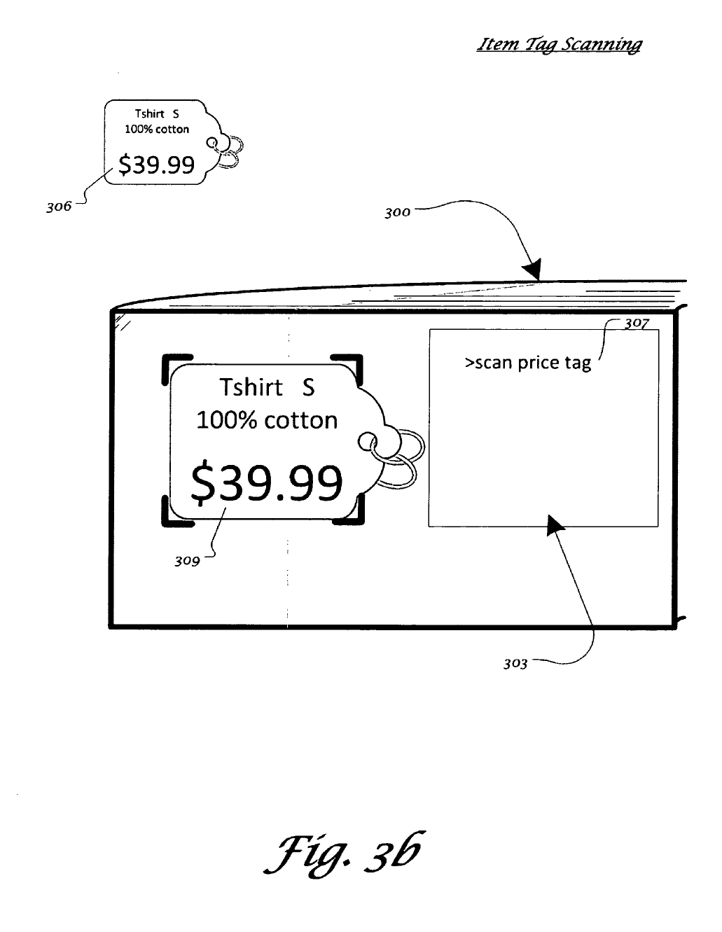

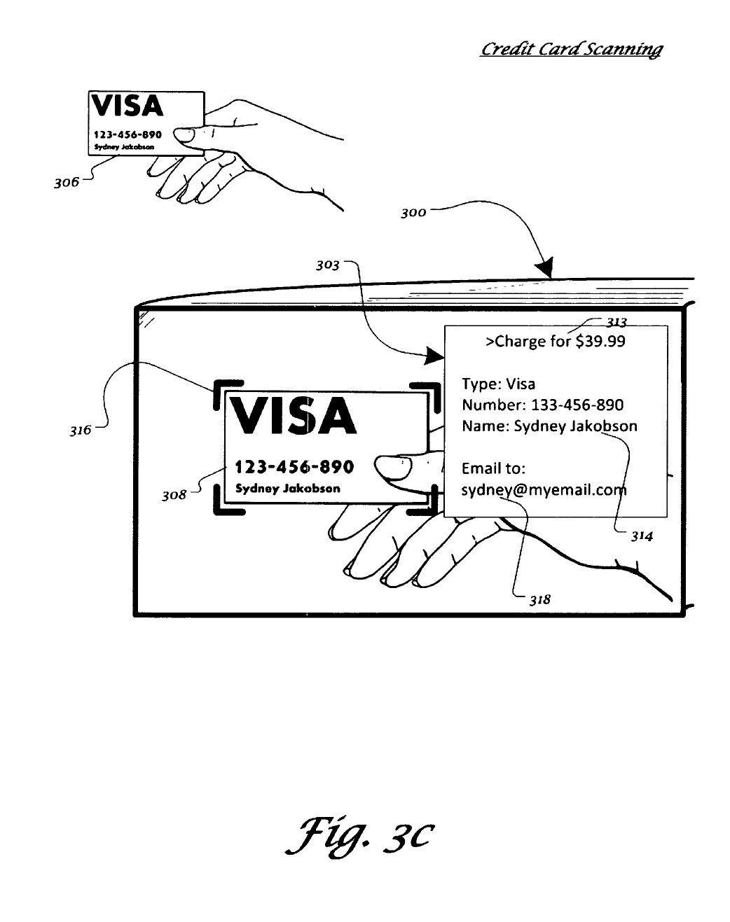

FIGS. 3a-3c are generalized block diagrams illustrating utilizing a wearable computer with a display/an optical head-mounted display (“OHMD”) to conduct merchant-customer transactions, via credit card recognition, in one embodiment of the present invention. In some situations, facial recognition, depicted in FIGS. 2a-2c, may not be a preferred option; rather, a customer may display an object, e.g. a credit card, as form of payment.

Referring to FIG. 3a, a credit card 306 may be held a certain distance from the wearable computer, within the field of vision of the wearable computer's display/OHMD 300, such that an image 308 of the credit card 306 is visible in the OHMD 300. The merchant may issue an instruction (via voice, tap/touch/movement etc.) instruction the wearable computer to initiate a scanning/transmitting transaction. The merchant may be notified visually/audibly via feedback (e.g. the command “scan credit card” 304 may be display in a visual messaging area 303 of the OHMD 300.)

Referring now to FIG. 3b, the wearable computer may be used to capture information relating to the item being purchase (or other transaction-related items and documents.) For example, a price tag 306 may be presented to the merchant wearing the wearable computer, such that the merchant may use the OHMD 300 to identify the price tag 306 as price tag image 309. The merchant may issue a voice command “scan price tag” (displayed as feedback information 307) in the message area 303. In one possible embodiment, an optical recognition mechanism (“OCR”) may be implemented (e.g. as software running on the wearable computer) to recognize the dollar amount of the price tag 306 as “$39.99”. In another possible embodiment, the image 309 may be transmitted to an entity/device external to the wearable computer (e.g. a service on the internet) where the amount of the price tag 306 may be interpreted from image to dollar amount.

In response to the merchant's command, referring now to FIG. 3c, the credit card image 308 (or image of any other physical method of payment) may be captured (possibly with assistance from a visual cue 316, displayed overlaying the credit card image 308 in the OHMD 300). Payment information, captured via voice commands (or any other audio/visual means) may be displayed in the notification area 303 of the OHMD 300. In this example, information such as the amount to charge “Charge for $39.99” 313 (explained in FIG. 3b) may be displayed, in addition to information discerned about the form of payment (e.g. “Type: Visa Number: 133-456-890 Name: Sydney Jakobson” 314). The discerned form of payment 314 may be processed by the wearable computer; or, in alternate possible embodiments, a raw image of the method of payment, e.g. image 308, may be transmitted to the cloud for remote processing, and processed information, such as matched user email information 318, as well as discerned credit card number, may be returned.

In various other possible embodiments of the present invention, other types of items/objects may be utilized as forms of payment, by virtue of capturing their image via the wearable computer, transmitting their image to a processing entity and receiving transaction approval information. For example, bar codes, QR codes, printed checks, identification cards, passports, wearable objects, etc. may be used in lieu of the credit card 306 depicted in FIG. 3c.

FIG. 4 is a generalized flow diagram illustrating a system in which a wearable computer with a display (e.g. an optical head-mounted display “OHMD”) may be used to facilitate merchant transactions, in one embodiment of the present invention.

At step 402, the wearable computer may receive indication from the user (e.g. merchant wearing the wearable computer) to commence a transaction. The indication may be a voice command, a touch command, etc.

At step 404, an audio recording of the transaction may initiate. For example, a microphone associated with the wearable computer may be turned on and commence recording audio. The audio may include details of the transaction, such as price, terms, agreement, name of the buyer, identification of the item being purchased, etc.

At step 406, a video recording of the transaction may initiate. The wearable computer may be associated with a video camera (e.g. the video camera may be built in as per FIG. 1), and recorded video may be stored locally and/or streamed to an entity in the cloud. Video may also consist of one or more still pictures.

Please note that steps 404 and 406 are interchangeable and are not co-dependent; either step could take place before the other step and they may each start at end at different times. Steps 404 and 406 may capture the nature of the transaction, from the face of the buyer (to associate with method of payment) to a verbal agreement on cost to an image/video capture of a price tag associated with the item being purchased, etc.

At step 408, a user's command to transmit the captured information to a transaction service may be received. For example, the user—or merchant—may say “complete transaction” and in response, a voice-recognition algorithm on the wearable computer may, at step 410, transmit information captured in steps 404-408 to the remote service (e.g. a web-based processing/banking center) for processing.

At step 410, the information may be uploaded/transmitted to a remote source in the cloud, i.e. on the internet/intranet. Any audio/video captured may be transmitted electronically, via a WiFi network; or, via a Bluetooth (or similar) protocol to a tethered device, acting as a proxy to the interne (or destination network.) Video may be transmitted in any supported format, such a MPEG, AVI, MP4 etc. and/or as still images, such as JPEG, GIF, PNG etc. Audio may be transmitted as separate audio file(s) (e.g. MP3 encoded, as WAV etc.) or as an audio track of the video transmitted. Some or all of the audio/video may be transmitted in raw format—i.e. not transcribed into recognized words/characters); or, as transcribed images/words. (e.g. a purchase amount such as “$39.9” may be transmitted as an image of binary data; or, as transcribed textual data. The latter may be more efficient for transmission, but may require more processing by the wearable computer.) In addition to the information described above, in the present system, additional information identifying the user of the wearable computer (i.e. merchant) may be transmitted.

At step 412, the video/image(s) transmitted may be matched with images associated with user accounts, stored by a data center. For example, facial-recognition software may be used to match the face of the customer, as transmitted as video/image(s), against a large stored set of user images in an attempt to identify the customer as one of the people whose face is stored in association with an account. In a presently preferred embodiment, this step may be conducted by a processing entity remote to the merchant (i.e. “in the cloud”).

At step 414, it may be determined whether a match has been identifying between a user account, from among the data store of images-associated-with user accounts, and the received video/image(s) of the customer in the transaction. If at step 414 it is determined that no match exists, at step 424 a transmission back to the user device may be made, informing the merchant, via display in the OHMD of their device, at step 426, that the transaction has been declined.

If it is determined at step 414 that a positive identification has been made between the customer in the video/image(s) received and a user's image in the data store, at step 416 an account associated with the determined user's image in the data store may be discerned.

At step 418, amount of the transaction may be discerned. In one possible embodiment, the amount may be discerned from the audio received, for example, voice of the merchant saying “this is $39.99” and the customer saying “ok”. In this embodiment, the voices may be transcribed into data, such as a dollar amount to charge. In other possible embodiments, OCR may be used to discern a price from an image of a price tag, a bar code, or any other visual price indicator included in the video/image(s).

At step 420, an attempt may be made to debit the account identified at step 416 with the amount determined at step 418. For example, if the account holds a credit card number, an electronic communication may be sent to charge the credit card. In another example, if the account is associated with an electronic currency (e.g. PayPal®, BitCoin, etc.) and electronic debit may be attempted against those electronic currencies.

At step 422, it may be determined whether the charge attempt at step 420 has been successful. If the charge at step 420 has not been successful (e.g. the user has insufficient funds, or an institution handling the determined account has declined the transaction, etc.), at step 428 a transmission may be made to the user's wearable computer indicating the declined status of the transaction (in another embodiment, the decline message may include more details on the nature/reason of the decline.)

If at step 422 it is determined the charge-attempt at step 420 has been successful, at step 430 a message may be generated and transmitted to the wearable computer, indicating the transaction has been successful. (in another embodiment, the success message may include more details such as a confirmation number, question on whether to email the user a receipt of the transaction, etc.)

At step 426, a message may be displayed to the user/merchant on the wearable computer's OHMD, presenting the status of the transaction (e.g. approved vs. declined, etc.) and including any additional information on the transaction.

Please note that the flow diagram in FIG. 4 is an example of just one possible series of steps allowing a merchant equipped with a wearable computer to visually/audibly submit an electronic transaction for remote processing, and receive a confirmation/denial. In many other related embodiment, the same result could be accomplished with various other steps in between, and/or with the aforementioned steps taken in different order and/or with other steps inserted/deleted in between.

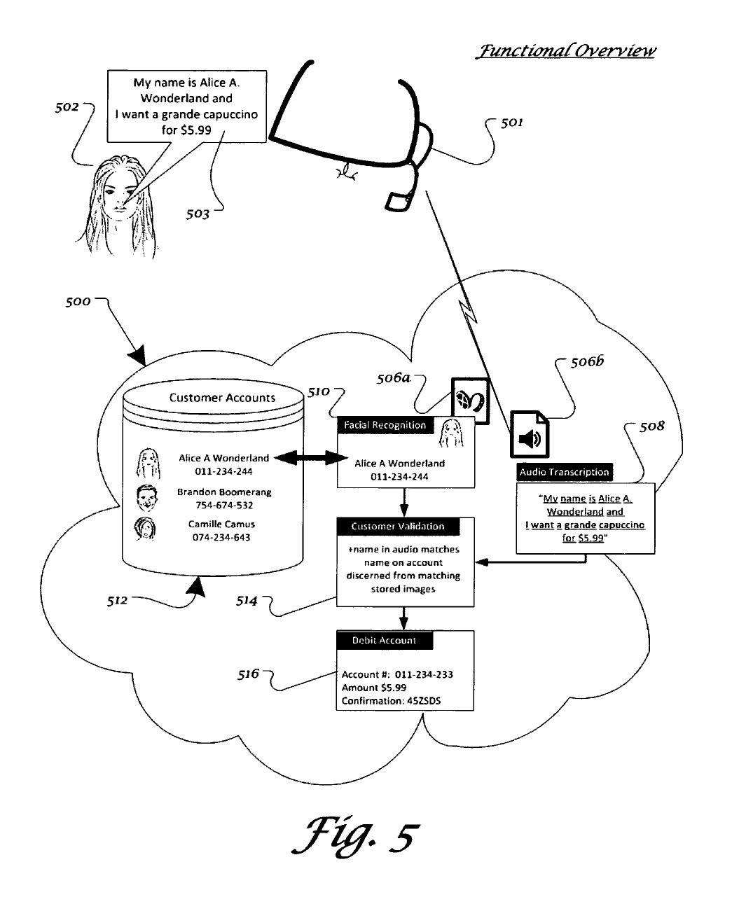

FIG. 5 is a generalized block diagram illustrating workings/components of a system in which a wearable computer (“device”) with a display/an optical head-mounted display (“OHMD”) may be used to facilitate merchant transactions, in one embodiment of the present invention. A merchant wearing the device may utilize hand-free optical/audio means of capturing and transmitting a transaction to the cloud (i.e. processing on the internet) and may receive back a confirmation of success or transaction denial.

A user (“merchant”) equipped with a wearable computer 501 may engage in a buy/sell transaction with another person (“buyer”) 502. The device 501 may be utilized to capture video (i.e. a video movie and/or digital stills), as well as voice recording of the transaction. The merchant may utilize the device 501 to record asking the buyer 502 what she would like to buy, and, optionally, provide additional information such as name. For example, the buyer may be recorded as saying as saying “My name is Alice A. Wonderland and I want a grande capuccino for $5.99” 503. The device 501 may also record a video including an image of the buyer's 502 face, as well as any other content relevant to the transaction (e.g. a menu-item, a price-list, a price tag, etc.) Recording audio/video may commence in various ways supported by the device 501 and its software; for example: via a voice command such as “start”, or via a manual tap of the device 501, etc.

The device 501 may be in communication with a service in the cloud (i.e. on the internet or intranet), either directly or via an intermediary device, such as a smart phone (or any other electronic device connected to the cloud, tethered electronically to the device 501.) Communication may be facilitated via an IP communication between the device 501 and a service in the cloud 500, using technology such as POSTing/GETing to a http or https website, RESTful communication, or any other protocol over any port supported by any internet-based technology allowing for client/server communication. Information identifying the wearable computer—and hence identification of the user/merchant—may also be included and utilized to complete the financial transaction.

The cloud 501—based service may receive from the device 501 audio 506a and video 506b file(s) (the files may be disparate files, or combined into a single video file with audio.) the audio 506a and video 506b, recorded by the device 501, may contain the entirety of the parameters required for a legal commercial transaction: who the buyer is, what is being bought and for how much/what terms—as well as a verbal agreement by the buyer. For example, the video portion may include the buyer's 502 face, a voice recording 503 identifying the buyer 502 by name and mentioning the item purchased and its price, etc.)

The cloud 501-based service may transcribe the audio portion of the transmission with an audio-transcription process 508, wherein recognizable words in the transaction, such as the buyer's name, amount of transaction, etc. are transcribed. If the audi-transcription process fails to identify one or more of these key elements, the transaction may be declined and a transmission may be made back to the device 501 declining the transaction. In another possible embodiment, the device 501 may conduct the audio transcription prior to transmitting to the cloud 500, in which case the user(s) may be asked to repeat words until the words are recognized, and the service in the cloud 500 may receive a transcribed text of key words rather than a raw audio file.

A facial recognition module 510 may be utilized to recognize the face of the buyer 502 from the video and/or stills received from the device 501. In one possible embodiment, if a facial-recognition algorithm used by the facial recognition module 510 fails to recognize a face, the device 501 may be notified of a declined transaction and the merchant may be asked to re-try. The facial recognition module 510 may also compare the buyer's 502 face with digitized face images stored in a customer accounts data store 512, attempting to find a positive match between the discerned face of the user 502 and at least one account-bearing customer face image in the data store 512.

A customer-validation module 514 may further validate the buyer 502 by attempting to compare information identifying the buyer 502, such as the buyer's name derived from the voice transcript in module 508, with information stored in the customer accounts data store 512 (in this example, making sure the transcribed customer name “Alice A. Wonderland” matches name on the account “011-234-244” discerned in module 510.)

Following positive identification of the correct customer and his/her account in modules 510 and 514, at module 516 the identified account may be debited the amount discerned earlier (e.g. $5.99 discerned in module 508) A confirmation may be generated and transmitted back to the merchant (e.g. for display in their wearable device 501) and/or to the buyer 502 (e.g. via email).

Kindly note that the modules 508, 510, 514 and 516 represents a generalized system/algorithm broken down into modular components for illustrative purposes only. In a real-life implementation of the present invention, operations performed in the aforementioned modules may be split and re-combined into other modules; the aforementioned modules may be performed by hardware and systems residing in different locations; and order of execution of the modules and their functionality may be altered (e.g. a person's face may be recognized prior to their voice being subjected to transmission, etc.)

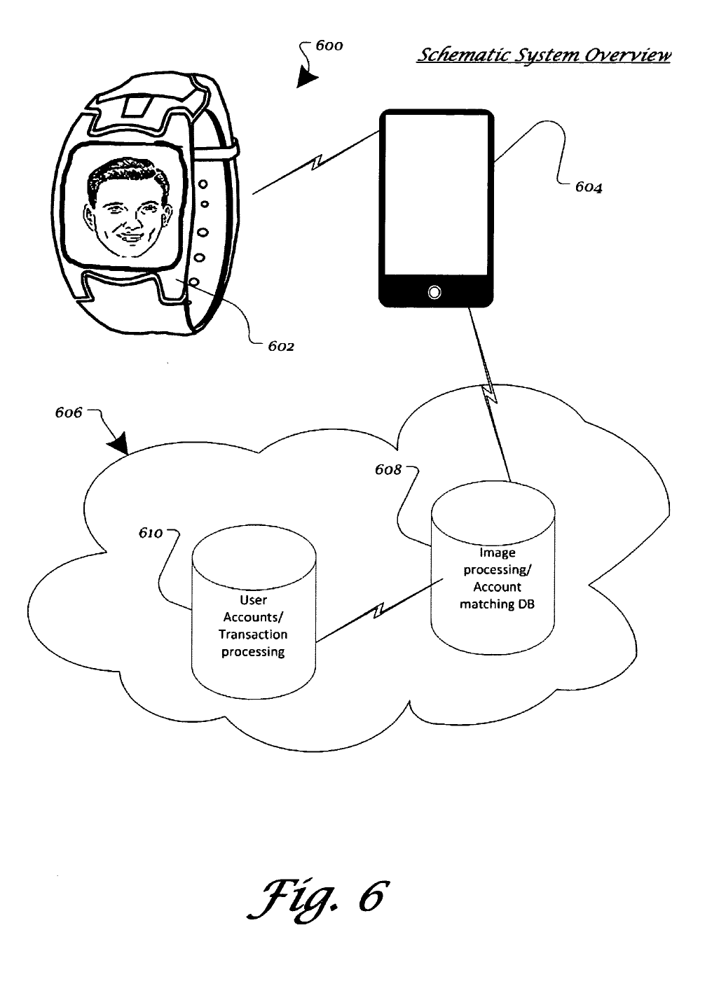

FIG. 6 is a generalized block diagram 600 illustrating one system in which a wearable computer with a display may be used to facilitate merchant transactions, in one embodiment of the present invention. A wearable computer with a display (“wearable device”) 602 may be coupled with a smart phone 604. The wearable device 602 may be a watch-based device (e.g. an Android® Smartwatch) capable of audio/video recording. The coupling may be achieved via Bluetooth technology, or any other electronic coupling technology. The purpose of the smart phone 604 (e.g. Google Android®-based device, or an Apple iPhone®, or any equivalent electronic device used for cellular and/or network communication) may be used to facilitate communications between the wearable device 602 and the interne (or “cloud”) 606.

Transactional information captured by the wearable device 602 may be relayed to a cloud 606 based service 608 handling imagine processing/account matching (e.g. identifying the merchant and customer, determining identity of the customer, determine account associated with the customer, determining legal/financial terms of the transaction, etc.) Once a customer and his/her account have been positively identified, and all aspects of the transaction have been discerned, a transaction processing service 610, in the cloud 606, may handle the actual financial transaction (e.g. debiting an account, issuing account credit, etc.)

In one possible embodiment, the smart phone 604 may be a conduit for electronic communication between the wearable device 602 and the services 608 and 610 in the cloud 606. In other possible embodiments, the smart phone 604 may perform digital processing, such as discerning properties of the transaction (e.g. transcribing voice recording to identify people, terms, etc. and/or processing image of customer captured by the wearable device 602, etc.)

While various embodiments of the present invention have been described in detail, it is apparent that further modifications and adaptations of the present invention will occur to those skilled in the art. However, it is to be expressly understood that such modifications and adaptations are within the spirit and scope of the present invention.

What is claimed is:

1. A method of facilitating a commercial transaction via a wearable computer coupled to a display, comprising:
presenting a wearable computer coupled to the Internet (“cloud”), wherein the wearable computer is capable of recording and transmitting digital video and audio and is coupled to a display;
detecting a person is within field of view of the display;
recording at least one image of the person, wherein the at least one image includes the person's face;
recording additional information defining a transaction;
transmitting the image of the person and the additional information to a remote computer;
determine the person's image matches a digitally-stored identity;
determine account associated with the matched digitally-stored identity, wherein the account is capable of having financial transactions applied against it;
discerning monetary transactional information from the additional information;
attempting to apply a financial transaction to the account, wherein the financial transaction corresponds to the discerned monetary transactional information;
transmitting to the wearable computer status information related to the attempted financial transaction; and
displaying the status information on the display.

2. The method of claim 1, wherein the additional information includes digital audio.

3. The method of claim 2, wherein the digital audio includes information defining one or more of: item or service being purchased, purchase price, parties' consent for transaction, name of the person, information identifying the person, information identifying a means of payment.

4. The method of claim 1, wherein the remote computer is part of a cloud-based service.

5. The method of claim 3, wherein the digital audio is digitally transcribed in the cloud-based service.

6. The method of claim 1, wherein the digital audio is digitally transcribed by the wearable computer.

7. The method of claim 1, wherein combination of data derived from the at least one image of the person and the additional information, includes sufficient information to constitute a valid and binding legal transaction.

8. The method of claim 1, wherein a cellular device is paired with the wearable computer.

9. The method of claim 8, wherein the cellular device acts as a conduit between the wearable computer and the remote computer.

10. The method of claim 8, wherein the cellular device processes at least some of: the digital audio and/or the at least one image of the person.

11. The method of claim 1, wherein a financial transaction between the person and a user wearing the wearable computer is conducted, wherein the financial transaction is based at least in part on the digital audio and/or the at least one image of the person.

12. The method of claim 11, wherein information on outcome of the financial transaction is transmitted to the wearable computer.

13. The method of claim 12, wherein the information on the outcome is displayed on the wearable computer.

14. The method of claim 1, wherein a voice command commences recording and transmitting at least one of: the at least one image of the person and/or the additional information.

15. The method of claim 1, wherein the display is an optical head-mounted display.

16. A system for conducting commercial transactions via a wearable computer coupled to a display, comprising the steps of:
means for capturing at least one face image of a first person acting as buyer in a commercial transaction, wherein the at least one face image is captured via the display of the wearable computer used by a second person acting as merchant;
means for capturing additional transactional information including: identification of goods-or-services being transacted and monetary amount owed via at least one of: an image or video captured by display and/or a sound recording captured by the wearable computer;
means for transmitting the at least one face image and the additional transactional information to a remote processing entity;
means for discerning identity of the first person from the at least one face image;
means for associating an account with the identity of the first person;
means for discerning the additional transactional information via at least one of: processing the additional transactional information with optical-recognition software and/or transcribing audio captured in the additional transactional information via an audio-transcription software;
means for attempting to debit the user account with the monetary amount owed;
means for transmitting results of attempt to debit the user account to the wearable computer; and
means for displaying the results to the second person.

17. The system of claim 16, further characterized by being capable of including the at least one face image and/or the at least one image of the item in movie-type electronic media.

18. The system of claim 16, further characterized by being capable of capturing the at least one face image and/or the additional transactional information, in response to a voice-command issued to the wearable computer.

19. The system of claim 16, further characterized by being capable of including in the additional information at least one of: a video capture and/or a voice capture of a consent for the commercial transaction by the first person.

20. The system of claim 16, further characterized by being capable of including verbal identification of the first person in the additional transactional information.

21. The system of claim 16, further characterized by being capable of including identification of the wearable computer in the additional transactional information.

22. The system of claim 21, including means to utilize the identification of the wearable computer to discern identity of the second person acting as merchant.

23. The system of claim 16, further characterized by being capable of including identification of the second person acting as merchant in the additional transactional information.

24. The system of claim 16, further including means of discerning identity of the first person from the at least one face image via facial-recognition software.

25. The wearable computer of claim 16, further including ability to process at least some of the one of: the at least one face image and/or the additional transactional information prior to the transmittal to the remote entity.

26. The wearable computer in claim 25, further including ability to transmit results from the processing to the remote entity.

27. The system of claim 16, further including means of processing the additional transactional information prior to processing the at least one face image.

28. The system of claim 27, further characterized by being capable of discerning identity of the user from the additional transactional information.

29. The system of claim 28, further characterized by being capable of further confirming the identity of the user by analyzing the at least one face image.

30. The system of claim 16, further including means of permanently storing transactional data, the transactional data comprising at least one of: the at least one face image, the additional transactional information.

31. The system of claim 30, further characterized by being capable of permanently storing the transactional data in association with the user account.

32. The system of claim 30, further characterized by being capable of permanently storing the transactional data in association with the second person.

33. The system of claim 16, further characterized by being capable of displaying on an optical head-mounted display.
